(19) United States
(12) Patent Application Publication
(10) Pub. No.: US 2025/0336268 A1
(43) Pub. Date: Oct. 30, 2025

(54) SELF-SERVICE ACTIVATION AND REDEMPTION IN A GAMING DEVICE

(71) Applicant: INAMAX GA, Inc., Duluth, GA (US)

(72) Inventors: Nizar DAMANI, Duluth, GA (US); Shiv Dutt BHATORIYA, Dunwoody, GA (US)

(21) Appl. No.: 19/182,963

(22) Filed: Apr. 18, 2025

Related U.S. Application Data
(60) Provisional application No. 63/639,530, filed on Apr. 26, 2024.

(51) Int. Cl. G07F 17/32; G06Q 50/34

(52) U.S. Cl. CPC G07F 17/3244; G06Q 50/34; G07F 17/3237

(57) ABSTRACT

Techniques are described for techniques for self-service activation and redemption for gaming devices. In some embodiments, the techniques include identifying, by a gaming kiosk or a gaming device, user input comprising a gaming identifier delivery type; transmitting a gaming identifier request specifying the gaming identifier delivery type; and transferring access to the gaming identifier and user credits by transmitting the gaming identifier to a client device; or adding the gaming identifier to a player card.

### CROSS-REFERENCE TO RELATED APPLICATIONS

This application claims the benefit of U.S. Provisional patent application titled, “SELF-SERVICE ACTIVATION AND REDEMPTION IN A GAMING DEVICE,” filed on Apr. 26, 2024, and having Ser. No. 63/639,530. The subject matter of this related application is hereby incorporated herein by reference.

### Field of the Various Embodiments

This application relates to techniques for gaming devices, and more specifically, self service activation and redemption for gaming devices.

### Description of the Related Art

Class three gaming devices are defined by the Indian Gaming Regulatory Act. Class three devices encompass a broadly defined set of devices and games and include devices that are commonly referred to as slot machines. Skill-based games can also be operated on a slot machine but may not necessarily encompass a class three gamine device. The term slot machine is generally derived from slots on the machine that were historically used to insert and/or retrieve coins from the device. However, in modern class three and/or skill-based gaming devices, alternative ways to pay to play games on the devices and redeem cash or rewards from the device are used that do not involve coins.

As the foregoing illustrates, what is needed in the art is improved techniques for activation and redemption for gaming devices.

### SUMMARY

One embodiment of the present disclosure sets forth a gaming kiosk or a gaming device that identifies user input comprising a gaming identifier delivery type, transmits a gaming identifier request specifying the gaming identifier delivery type, and enables access to the gaming identifier and user credits by transmitting the gaming identifier to a client device, or adding the gaming identifier to a player card. In some examples, the gaming device or gaming kiosk transmits the gaming identifier request to a gaming system that transmits the gaming identifier to the client device, for example, as a link to a website that includes the gaming identifier.

In further embodiments, the present disclosure describes identifying a gaming identifier request, generating or identifying a gaming identifier, and providing the gaming identifier or a machine-readable code comprising the gaming identifier via a link transmitted to a client device phone number, data transmitted to a gaming device, or data transmitted to a gaming kiosk. In some examples, the machine-readable code includes the gaming identifier and one or more of a PIN or the telephone number for verification.

At least one technical advantage of the disclosed techniques relative to the prior art is that the disclosed techniques enable users to load and/or redeem without the assistance of an attendant. Instead, an unattended kiosk, gaming device, or even a user's personal device can be utilized to redeem credits for gift cards, store credits, or other electronically redeemed rewards that can be redeemed by invoking an application programming interface (API) over a network.

Further technical advantages involve providing self service activation and redemption of user credits, thus providing greater accessibility while maintaining reliability, data security, and minimizing (or eliminating) the use of personally identifying information. Further technical advantages involve enabling gaming devices and kiosks to verify authenticity of the gaming identifier when network access is unavailable or intermittently connected.

These technical advantages represent one or more technological improvements over prior art approaches.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is an illustration of a gaming environment according to various embodiments of the present disclosure.

FIG. 2 is a diagram of the gaming environment according to various embodiments of the present disclosure.

FIG. 3 is one example of the operation the gaming environment according to various embodiments of the present disclosure.

FIG. 4 is a flow chart performed by the gaming device or kiosk of the gaming environment according to various embodiments of the present disclosure.

FIG. 5 is a flow chart performed by the gaming system of the gaming environment according to various embodiments of the present disclosure.

### DETAILED DESCRIPTION

As noted above, class three gaming devices encompass a broadly defined set of devices and games and include devices that are commonly referred to as slot machines. The term slot machine is generally derived from slots on the machine that were historically used to insert and/or retrieve coins from the device. However, in modern class three gaming devices, alternative ways to pay to play games on the devices and redeem cash or rewards from the device are used that do not involve coins.

Patrons can wager money or credits on a game played on a gaming device. The gaming device can utilize probability to randomly select one of several potential outcomes or the user's skill can determine the outcome. In many contexts, patrons often must consult with an attendant to cash in or cash out of a gaming device, which requires staffing of one or more gaming devices in a location where the device is installed. However, some operators of gaming devices might desire to have attendant-less installations of gaming devices whereby players can purchase credits or plays on the gaming devices and then subsequently redeem credits left on the device, or “cash out” without requiring the assistance of an attendant.

In many markets, users can play games on a class three gaming device using cash or a card onto which credits to play a game can be loaded. The credits can be loaded onto a card, such as loyalty or player's card, by an attendant utilizing an administrator terminal that is in communication with the gaming device and a remotely located gaming system or gaming environment that tracks player data. Users can cash out or redeem credits earned from gameplay on the gaming device or early replay credits by returning to the attendant to redeem credits for merchandise, store credits, gift cards, or cash in some markets depending upon regulatory requirements.

Examples of the disclosure provide systems whereby users can load credits onto a player's card for use in a gaming device without the assistance of an attendant. Additionally, examples of the disclosure also provide systems whereby users can redeem credits earned from a gaming device without needing the assistance of an attendant. Instead, unattended kiosk can be utilized to redeem credits stored on a player's card for gift cards, store credits, or other electronically redeemed rewards that can be redeemed using an application programming interface (API) over a network.

In the following discussion, a general description of the system and its components is provided, followed by a discussion of the operation of the same.

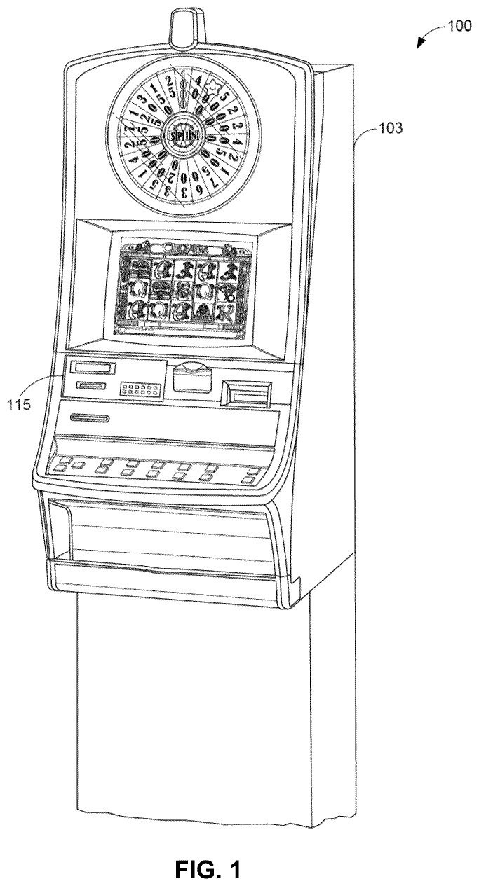

With reference to FIG. 1, shown is a gaming environment 100 according to various embodiments. The gaming environment 100 includes a gaming device 103. The gaming device 103 can have one or more displays to facilitate the playing of wagering game, such as, for example, display 106. The gaming device 103 can include a player tracking module 115.

The player tracking module 115 can communicate with one or more gaming systems and can enable a gaming device 103 to track game play activity of the patron. The player tracking module 115 can accept a player's card and communicate with another system to determine an amount of user credits available on the player's card to play games on the gaming device 103. The gaming device 103 can also include a cash in device, such as a bill validator or a coin acceptor. These cash in devices can be used by the patron to deposit a physical currency in the gaming device 103. For example, the bill validator can receive monetary notes. The bill validator can verify that the bill deposited is a real bill rather than a fake bill. The bill validator can send the monetary value and validity of each bill deposited to game application executed in the gaming device 103. In some implementations, a user can obtain credits to play games through an electronic payment mechanism, such an electronic payment, a credit or debit card with a magnetic stripe, a Near-Field Communication (NFC) enabled card or device, or via a digital wallet. The game application can increment a cash balance in a wagering game using the monetary value.

The bill validator can also scan a barcode of a ticket deposited in the bill validator. Data corresponding to the barcode can be transmitted to the game application. The game application can verify the barcode with the gaming system to determine whether there is a credit balance associated with the deposited ticket. The gaming device 103 can also include a cash out device such as a ticket printer. When the patron wishes to terminate a gaming session, the patron can provide an input using an input device to initiate a cash out. The game application can cause the ticket printer to print a cash out ticket with a barcode. This barcode corresponds to data stored in one or more gaming system. The gaming system can associate the monetary value of the credit balance at the gaming device 103 with the barcode data. A user can utilize the ticket to obtain cash, gift cards, merchandise, or other items of value from a gaming kiosk. Alternatively, the player tracking module 115 can directly dispense cash, gift cards, merchandise, or other items of value to the user. The game application can also dispense a gift card directly to the user.

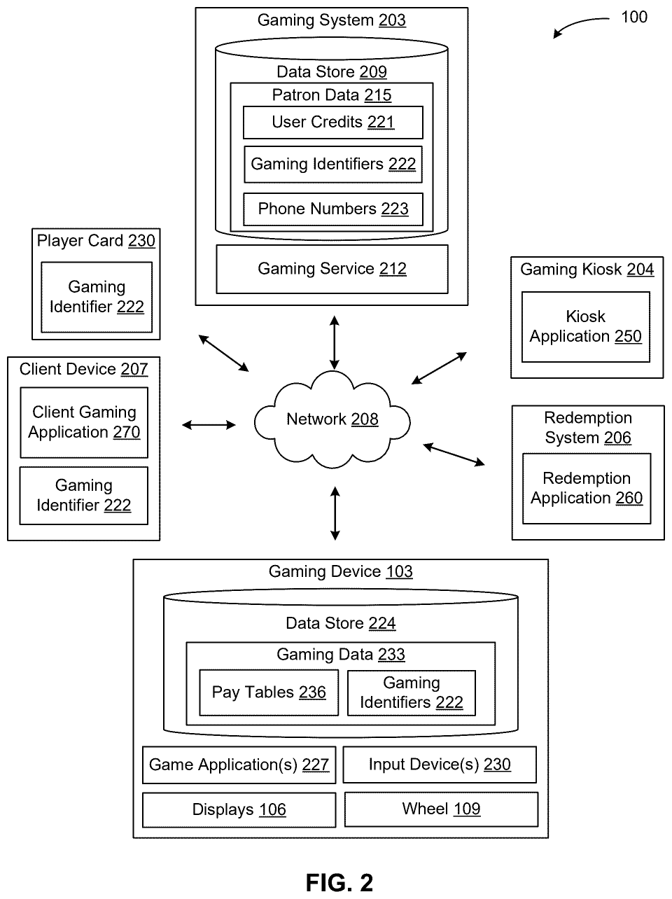

With reference to FIG. 2, shown is a gaming environment 100 according to various embodiments. The gaming environment 100 includes a gaming system 203, a gaming kiosk 204, a redemption system 206, a client device 207, and a gaming device 103, which are in data communication with each other via a network 208. In some embodiments, the gaming environment 100 includes a player card 230. The gaming device 103 can have one or more displays to facilitate the playing of wagering game, such as, for example, display 106. The network 208 can include, for example, the Internet, intranets, extranets, wide area networks (WANs), local area networks (LANs), wired networks, wireless networks, other suitable networks, etc., or any combination of two or more such networks.

The gaming system 203 can include a data store 209 and a gaming service 212. The data store 209 can include patron data 215 including user credits 221, as well as gaming identifiers 222, phone numbers 223, and potentially other data. The user credits 221 can include credits, such as a dollar amount or other currency amounts, that are credit to a particular user or patron. Patron data 215 can correspond to a particular user or a particular player's player card 230 that is activated by a user, for example, using a gaming kiosk 204 and/or a gaming device 103. The user can spend or accumulate user credits 221 by playing games on a gaming system 203, which can communicate with the gaming service 212 to report the amount of gaming service 212 that are associated with a user or a player card 230 utilized by a user on the gaming device 103.

A gaming identifier 222 can be uniquely associated with one or more of a phone number 223, a Personal Identification Number (PIN) number and/or the like.

The gaming device 103 can include a data store 224, a game application 227, one or more displays 106, one or more input devices 230, a wheel 109, and other components. In other embodiments, the gaming device 103 corresponds to a personal computer, mobile device, or other computing device of a patron in communication with the gaming service 212 and configured to allow the personal computer to securely execute a game application 227. As an example, while on a personal computer, a patron can play on an online slot machine or card game served up from a gaming service 212. The personal computer can include special purpose hardware to verify the location of the personal computer is within a particular gaming jurisdiction of a plurality of different gaming jurisdictions. For example, the location can be identified based on a geolocation such as a global positioning system location. The special purpose hardware can also enable and verify the secure execution of one or more gaming applications 227 with the server (e.g., the gaming system 203). The verification of the gaming application 227 by the gaming service 212 can ensure that game application 227 is not modified by the patron and to prevent cheating. In some embodiments, the wheel 109 and/or other gaming graphics can be rendered on the display 106. As an example, if a personal computer has only one display 106, the display 106 can be used for the wagering game and the wheel-based gaming feature.

The gaming device 103 can include, for example, a slot machine. The gaming device 103 can be communicably coupled to a gaming system 203 that includes one or more backend servers facilitating functionality of a slot machine. As such, the gaming system 203 can employ a plurality of computing devices that may be arranged, for example, in one or more server banks or computer banks or other arrangements. Such computing devices may be located in a single installation or may be distributed among many different geographical locations. As an example, the gaming device 103 can include one or more computing devices located on a floor of a casino in a slot machine, while one or more computing devices of a gaming system 203 may be part of a cloud or a server bank. The gaming device 103 can be associated with a particular location (e.g., an address, geolocation, and/or the like), as well as an enterprise and/or operator that manages the particular gaming device 103. The gaming system 203 stores, in the data store 209, gaming device data that associates a particular location with a particular gaming device 103 (e.g., by a unique device identifiers) or type of gaming device 103 (e.g., a model number or set of gaming applications 227) among a number of different types of gaming devices 103.

Various applications and/or other functionality may be executed in the gaming device 103 according to various embodiments. Also, various data is stored in a data store 224 that is accessible to the gaming device 103. The data stores 209 and 224 can be representative of a plurality of data stores 209 and 224 as can be appreciated. In some embodiments, one or more data stores 224 can be hosted separate from the gaming device 103 by the gaming system 203. The data stored in the data stores 209 and 224, for example, are associated with the operation of the various applications and/or functional entities described below.

The components executed on the gaming device 103, for example, include the game application 227, and other applications, services, processes, systems, engines, or functionality not discussed in detail herein. The game application 227 is executed to provide a wagering game, such as for example, a slot game, a card game, a bingo game, or other wagering game. The game application 227 can render the wagering game on one or more displays 106. The game application 227 can also receive inputs from one or more input devices 230. The input devices 230 can include one or more buttons, one or more touch screen input devices, one or more motion sensors, a mouse, a keyboard, a card reader device, cameras, eye tracking devices, or another input. An input device 230 can also include an imaging device such as a scanner or a camera device, which can scan a quick response (QR) code, bar code, or any other machine-readable code. The machine-readable code can include a series of dots, bars, or another code that embeds and/or is otherwise associated with certain data that is generally human-indecipherable or incomprehensible by persons or users that view the code without a reader device.

An input device 230 can also include a card reader that can read a player card 230 such as a magnetic stripe card, a smart card, RFID card, or any other type of card that has a unique identifier with respect to other cards. Such a card can be a player card 230 that can be loaded with credits or money that can be used to play games on the gaming device 103. The user credits 221 loaded onto a player's card may not be physically written to the player card 230, but instead stored within the data store 209 so that a gaming device 103 or a gaming kiosk 204 can query the gaming system 203 to determine the amount of user credits 221 that are associated with a given card's unique identifier such as the gaming identifier 222.

The data stored in the data store 224 of a gaming device 103 includes, for example, gaming data 233 and potentially other data. The gaming data 233 can include pay tables 236, gaming identifiers 222 and potentially other gaming data such as phone numbers 223 associated with gaming identifiers 222 or hashed data that enables a gaming device 103 to verify that a gaming identifier 222 and phone number 223 match. The pay tables 236 can include a list of payouts for the gaming device 103. The pay tables 236 can include payouts for different combinations of symbols or other occurrences within a game executed by the gaming device 103.

A gaming kiosk 204 can comprise a computing device that can dispense or activate player cards 230 on behalf of an operator of the gaming device 103. Player cards 230 can start as unactivated or deactivated cards that are associated with zero user credits 221. The gaming kiosk 204 can represent one or more computing devices that are associated with the operator, such as a physical location in which a gaming device 103 is placed. To play a game on one or more gaming device 103, a user can obtain player card 230. In one example, a rack or a stack of unactivated player cards 230 can be provided at each gaming device 103 or at a location where multiple gaming devices 103 are installed.

An unactivated player card 230 can be activated by loading money or other credits onto the player card 230 using the gaming kiosk 204 and/or using the gaming device 103. A player card 230 can be inserted into a gaming kiosk 204 or the gaming device 103. The gaming kiosk 204 and/or the gaming device 103 can accept cash, debit, credit, or other forms of payment. Once validated, the payment can be converted to user credits 221 that can be associated with a unique identifier such as the gaming identifier 222 of the player card 230. In operation, the gaming kiosk 204 or gaming device 103 activating the player's card can communicate over the network 208 with the gaming service 212, which can apply the user credits 221 to the player card 230 and create an association between the player card 230 (and/or the gaming identifier 222) and the user credits 221 in the data store 209. In some examples, the gaming identifier 222 is also associated with a phone number 223 provided by the user. However, in some embodiments, the gaming identifier 222 is unassociated with any personally identifiable information of the user, and is unassociated with any phone number 223. In some embodiments, the gaming identifier 222 is associated with a single item of personally identifiable information such as the phone number 223.

In some embodiments, the gaming system 203 associates a single gaming identifier 222 and/or player card 230 with gaming-network-specific user credits 221 that are usable only for gaming devices 103 (and/or game applications 227) associated with a particular gaming network. A gaming network can include all or a subset of gaming devices 103 for a particular enterprise, a particular set of enterprises, a particular operator or set of operators, and/or the like. In some embodiments the subset of gaming devices 103 of the gaming network is specific to an enterprise or operator (or set of enterprises or operators) as well as one or more states, countries, or other legal jurisdictions. For example, a gaming identifier 222 and/or player card 230 can have a first set of user credits 221 that is exclusively usable for a first gaming network, and a second set of user credits 222 that is exclusively usable for a second gaming network. Alternatively, the gaming identifier 222 and/or player card 230 is exclusive to a gaming network.

A client device 207 can include a personal computer, a phone device, a tablet device, a smart watch device, another mobile device, or any kind of computing device. The client device 207 includes, without limitation a gaming application 270 and, once obtained, a gaming identifier 222.

The user can utilize the player card 230 or a client device 207 to play games on the gaming device 103 via the game application 227. In the example of the client device 207, the client device 207 can use a client gaming application 270 and/or a browser, a wallet application, or another client application. In some examples, the application executed by the client device 103 accesses a website served up by the gaming system 203. The client gaming application 270, other application, and/or the website can enable the client device 207 to present a machine-readable code or a wireless transmission (e.g., near-field communication and/or the like) in lieu of a player card 230.

During game play, the gaming device 103 can deduct user credits 221 from the player's card for gameplay on the game application 227. The gaming device 103 can synchronize the user credits 221 with the gaming service 212 in real time or periodically. If the user wins gameplay on the game application 227, user credits 221 can be added to the player card 230 (e.g., to the patron data 215 corresponding to the player card 230 and/or gaming identifier 222). If the user does not win gameplay on the game application 227, user credits 221 can be deducted from the player card 230. User credits 221 can also be deducted from the player card 230 as payment for individual games or turns of a game on the game application 227. Once the user has finished playing one or more games on the gaming device 103, the user can “cash out”, or redeem. Generally, adding or removing credits 221 and other data with respect to the player card 230 can refer to updating the patron data 215 corresponding to the player card 230 and/or gaming identifier 222, for example, in the gaming system 203.

The player can then request, via the gaming device 103 or the gaming kiosk 204, redemption of the user credits 221. The player can present a player card 230 or client device 207 to the gaming device 103 or the gaming kiosk 204. A kiosk application 250 running on the gaming kiosk 204 or the game application 227 can communicate with a redemption system 206 running a redemption application 260 via API's provided by the network 208. The redemption system 206 can be operated by an issuer of gift cards, cash, or other rewards. Using the gaming device 103 or the gaming kiosk 204, the user can request a gift card of a specified value equivalent to at least a subset of the user credits 221 (e.g., a subset of the gaming-network-specific user credits 221) associated with the player card 230 and the gaming device 103 or the gaming kiosk 204. The gaming kiosk 204 or gaming device 103 can request the redemption system 206 to issue a gift card or other type of card via an API provided by the redemption system 206. The redemption system 206 can take steps to issue or activate a gift card or other reward, which can be dispensed by or activated by the gaming device 103 or the gaming kiosk 204. The gaming device 103 or the gaming kiosk 204 can also cause the gaming system 203 to deduct an appropriate amount of user credits 221 from the corresponding patron data 215.

In one example of the operation of the gaming environment 100, a user interacts with a gaming kiosk 204 (or gaming device 103) and requests the gaming identifier 222 be provided using player card 230 or a client device 207. In some examples, a phone number 223 is entered through a user interface and transmitted to the gaming system 203 along with an indication of how the gaming identifier 222 is to be used. The gaming system 203 generates and/or logically associates the gaming identifier 222 with the phone number 223 and an amount of user credits 221 indicated in the request and backed by collected or otherwise identified funds.

If the gaming identifier 222 is to be provided using a player card 230, the gaming system 203 transmits the gaming identifier 222 to the gaming kiosk 204 (or gaming device 103). The gaming kiosk 204 (or gaming device 103) embeds or stores the gaming identifier 222, and in some examples the phone number 223 and one or more user credit 221 amounts (e.g., for one or more gaming networks), in a chip or data store of the player card 230 and dispenses or provides the player card 230. In some embodiments, a player card 230 can have a printed portion that shows a machine-readable code that encodes the gaming identifier 222 and/or the phone number 223. In some embodiments, the gaming kiosk 204 or the gaming system 203 generates the machine-readable code that encodes the gaming identifier 222 and/or the phone number 223. Encoding or storing the phone number 223 along with the gaming identifier 222 and/or the user credits 221 enables the gaming device 103 to allow gaming even if the gaming device 103 is temporarily offline or has intermittent network access, because the gaming device 103 would otherwise use the gaming identifier 222 in a request to identify or verify the phone number 223 and/or the user credits 221.

If the gaming identifier 222 is to be provided using a client device 207, the gaming system 203 generates a machine-readable code that encodes the gaming identifier 222 and/or the phone number 223, generates a website that provides access to the machine-readable code, and a link to the website. The gaming system 203 transmits or sends the link to client device 207 using the phone number 223 as an endpoint identifier for the client device 207, for example using short messaging service or another messaging service. The client device 207 receives the link, for example, via the messaging service. A user interacts with a user interface element of the link. The link causes the machine-readable code to be (1) displayed and/or (2) data (including but not limited to the machine-readable code image) that includes the gaming identifier 222, the phone number 223, and/or the user credits 221, to be stored by the client gaming application 270 or a wallet application. The machine-readable code or other data that includes the gaming identifier 222, the phone number 223, and/or the user credits 221 enables the client device 207 to interact with a gaming device 103 to transfer user credits 221 in a manner analogous to the player card 230.

In some examples, the gaming device 103 periodically retrieves data such as a hash or other data structure that enables the gaming device 103 to input the phone number 223 and the gaming identifier 222 to verify authenticity of the gaming identifier 222. In some cases, this data also indicates a number of user credits 221. Alternatively, once verified the user credits 221 stored on the player card 230 or client device 207 (e.g., via client gaming application 270 or a wallet application) can be utilized and/or updated based on gameplay.

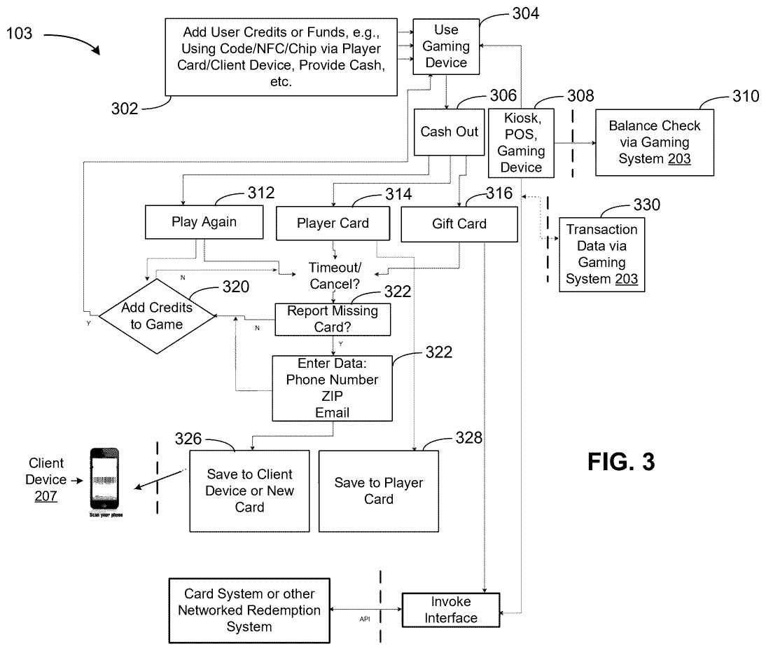

FIG. 3 is one example of the operation the gaming device 103 with other components of the gaming environment 100 according to various embodiments of the present disclosure. In this figure, the actions performed using the gaming device 103 are described with respect to elements that include, without limitation, input devices 230 and one or more displays 106.

At block 302, a user interacts with the gaming device 103 to add user credits 221 or funds. In some embodiments, the user adds user credits 221 to gaming device 103 by presenting a machine-readable code on a player card 230 and/or a client device 270 to a scanner or other input device 230 of a gaming device 103. In some embodiments, the user adds user credits 221 to gaming device 103 by presenting a chip, magnetic strip, RFID device, or other component of a player card 230 to a corresponding input device 230 of a gaming device 103. In some embodiments, the user adds user credits 221 to gaming device 103 by presenting a client device 207 that includes an RFID device, an NFC device, a WiFi Device, a Bluetooth device, or another wired or wireless communication interface of a client device 207 to a corresponding input device 230 of a gaming device 103. In some embodiments, the user adds user credits 221 to gaming device 103 by loading cash into a corresponding input device 230 of a gaming device 103. In the example of cash, the cash monies are converted to user credits 221 and added to an existing account (e.g., patron data 215). In some examples, the user credits 221 are additionally or alternatively stored in a data store of the player card 230 and/or client device 270. The gaming device 103 transmits transaction data to the gaming system 203 to be stored as patron data 215. In some examples, including but not limited to intermittent or disconnected network connectivity scenarios, the gaming device 103 stores transaction data (specifying the user credits 221, a gaming identifier 222, and other data) in a secure data store 224 at least until transmitted to the gaming system 203.

At block 304, the user interacts with a user interface of the gaming device 103. For example, the gaming device 103 executes a game application 227 to provide a wagering game, such as for example, a slot game, a card game, a bingo game, or other wagering game. The game application 227 can render the wagering game on one or more displays 106. The game application 227 can also receive inputs from one or more input devices 230.

At block 306, the user interacts with a user interface of the gaming device 103 to cash out, for example, at the end or completion of a portion of the game. The cash out options include, without limitation, options to play again, present a player card to add any additional user credits 221 (e.g., winnings, unspent cash from a cash addition, which are not currently stored on a player card 230), or redeem any additional user credits 221 to a gift card.

At block 308, a user interacts with the kiosk 204, a point of sale device, a client device 107 or the gaming device 103 to check a balance, add funds to the gaming device 103, and/or redeem user credits 221. Each of these devices can interact with one another to perform various functions. In the example of checking a balance, a user interacts with a user interface of the kiosk 204, a point of sale device, or the gaming device 103 to check a balance, and the device transmits a balance check request to the gaming system 203, which returns a number of user credits 221 in association with the gaming identifier 222 or user account for each of one or more gaming networks. In the example of redeeming user credits 221, a user interacts with a user interface of the kiosk 204, a point of sale device, or the gaming device 103 to invoke a programmatic interface such as an API of a redemption system 206, which redeems a number of user credits 221 (e.g., specified as a parameter in a redemption request that invokes the interface). Additionally, the transaction data such as the number of redeemed user credits 221 and the gaming identifier 222 are transmitted to the gaming system 203. In some examples, the redemption system 206 transmits the transaction data such as the number of redeemed user credits 221 and the gaming identifier 222 to the gaming system 203. The redemption system 206 redeems the user credits 221 by adding monies to a gift card, adding monies to an account preconfigured in association with the gaming identifier 222 or another redemption technique. In some examples, the redemption system 206 transmits a command to provide (e.g., dispense, initiate mailing, etc.) a gift card via the kiosk 204, point of sale device, or the gaming device 103. In some examples, this process enables the kiosk 204, point of sale device, or the gaming device 103 to redeem user credits 221 without an attendant.

At block 312, the user interacts with a user interface of the gaming device 103 to play again with any additional or remaining user credits 221. The process moves to block 304 and the user again plays a game using the gaming device 103.

At block 314, the user interacts with a user interface of the gaming device 103 to present a player card 230 to store/update any additional or remaining user credits 221 on the player card 230 and/or with the gaming system 203.

At block 316, the user interacts with a user interface of the gaming device 103 to request a gift card to redeem any additional or remaining user credits 221. In the example of redeeming user credits 221, the gaming device 103 invokes a programmatic interface such as an API of a redemption system 206, which redeems a number of user credits 221 (e.g., specified as a parameter in a redemption request that invokes the interface). Additionally, the transaction data such as the number of redeemed user credits 221 and the gaming identifier 222 are transmitted to the gaming system 203.

At block 320, the gaming device 103 adds user credits 221 for use in a game of the gaming device 103. In some cases, the gaming device 320 adds user credits 221 following a user interface interaction indicating to play again. In other cases, the gaming device 320 adds user credits 221 following a user interface interaction indicating to add funds to a player card, but no player card 230 is detected by the gaming device 103.

At block 322, if no player card 230 is detected by the gaming device 103, the gaming device 103 can generate one or more user interface elements that enable a user to report a missing player card 230. In some examples, to report a missing player card 230 the one or more user interface elements enable a user to enter certain data such as a phone number, a zip code, a PIN, and/or an email address. In some examples, the gaming device 103 transmits the data to the gaming system 203 for verification and/or locally verifies that the phone number, a zip code, a PIN, and/or email correspond to a gaming identifier 222. In some examples, the gaming device 103 or gaming system 203 verifies that the gaming identifier 222 was recently used at the current gaming device 103 or another gaming device 103 at the same location (and/or any location of the zip code). Based on the one or more verifications, the gaming device 103 or gaming system 203 invalidates or inactivates the player card 230 and invalidates or revokes the gaming identifier 222, and issues a new gaming identifier 222.

At block 326, the client device 103 provides the new gaming identifier 222 to the user via the client device 207, for example, over a network by transmitting a message to the phone number 223, or transmitting data using NFC, WiFi, Bluetooth, displaying a machine-readable code on the display 106 for scanning by the client device 207, and/or the like. Alternatively, the client device 103 provides the new gaming identifier 222 to the user via the client device 207, for example, by dispensing a new player card 230.

At block 328, the client device 103 adds user credits 221 to a player card 230. In some cases, the gaming device 103 adds user credits 221 to a player card 230 following a user interface interaction indicating to add user credits 222 to the existing player card 230. In that example, the client device 103 detects that the user has presented or inserted player card 230.

At block 330, the gaming device 103 transmits transaction data to the gaming system 203, for example, based on any of the actions discussed with respect to FIG. 3. Generally, transaction data can be provided to the gaming system 203 as user credits 221 are updated based on converting funds to user credits 221, redeeming user credits 221 as funds, adding user credits 221 based on gameplay, and/or removing user credits 221 based on gameplay. The gaming device 103 transmits transaction data to the gaming system 203 immediately, periodically, in a delayed asynchronous manner (e.g., in response to detecting network connectivity after a failure for intermittent network connections), and/or the like, in various embodiments.

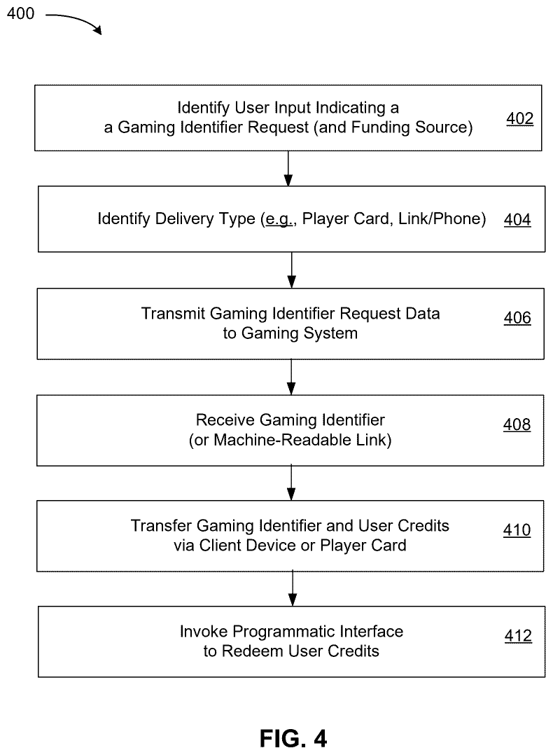

FIG. 4 is a flow diagram of method steps performed using a gaming device 103 or gaming kiosk 204 of the gaming environment 100, according to various embodiments. Although the method steps are shown in an order, persons skilled in the art will understand that some method steps may be performed in a different order, repeated, omitted, and/or performed by components other than those described in FIG. 4. Although the method steps are described with respect to the systems of FIGS. 1-3, persons skilled in the art will understand that any system configured to perform the method steps, in any order, falls within the scope of the various embodiments. While the method steps are described as being performed by the gaming device 103, the gaming kiosk 204 is also capable of performing the functionalities discussed.

As shown, a method 300 begins at step 402, where the gaming device 103 identifies a user input indicating a gaming identifier request. In some cases, the gaming device 103 also identifies a funding source and an amount of funds, for example, to ‘load’ on a player card 230 to otherwise associate with the gaming identifier 222 in the data stored by the gaming system 203. In some cases, the request causes a gaming system 203 to generate or identify the gaming identifier and associate the gaming identifier 222 with a user account. The funds can include cash physically collected at the gaming device 103, a card transaction from a bank or card provider (and associated network endpoint information), and/or the like. In various embodiments, the gaming identifier request is a request for a player card 230, a request to use a client device 207 as a player card 230, and/or the like.

At step 404, the gaming device 103 identifies a delivery type. In some embodiments, the delivery type includes a player card 230 delivery type, a link to phone number delivery type, a gaming device 103 to client device 207 delivery type, or other delivery types. The delivery type determines the process steps that follow.

At step 406, the gaming device 103 transmits the gaming identifier request data to the gaming system 203. The gaming identifier request data specifies one or more of the delivery type, the funding source, a phone number 223, an amount of funds (and/or user credits 221), and potentially other information. The gaming system 203 performs actions based on the gaming identifier request data For example, if the gaming identifier request data indicates a link to phone number 223 delivery type, then the gaming system 203 generates a machine-readable code that encodes the gaming identifier 222 and/or the phone number 223, generates a website that provides access to the machine-readable code (and/or data such as the machine-readable code image or other data that includes the gaming identifier 222, the phone number 223, and/or the user credits 221), and a link to the website. The gaming system 203 transmits or sends the link to client device 207 using the phone number 223 as an endpoint identifier for the client device 207, for example using short messaging service or another messaging service. The link causes the machine-readable code to be (1) displayed and/or (2) data (including but not limited to the machine-readable code image) that includes the gaming identifier 222, the phone number 223, and/or the user credits 221, to be stored by the client gaming application 270 or a wallet application. However, in other examples, the gaming system 203 transmits the gaming identifier 222 to the gaming device 103 that originated the request.

In step 408, the gaming device 103 receives the gaming identifier 222. In some embodiments, the gaming device 103 receives data that includes the gaming identifier 222, the phone number 223, and/or the user credits 221.

In step 410, the gaming device 103 provides the gaming identifier 222 and user credits 221 to the user in the delivery type specified. The gaming device 103 thereby enables self-service user credit 221 activation. For one kiosk or gaming device to player card 230 delivery type, the gaming device 103 embeds or stores the gaming identifier 222, and in some examples the phone number 223 and one or more user credit 221 amounts, in a chip or data store of the player card 230 and dispenses or provides the player card 230. For another kiosk or gaming device to player card 230 delivery type, the gaming device 103 prints a player card 230 that shows a machine-readable code that encodes the gaming identifier 222 and/or the phone number 223.

For one kiosk or gaming device to client device 207 delivery type, the gaming device 103 uses near field communication to transfer the data that includes the gaming identifier 222, the phone number 223, and/or the user credits 221 to the client device 207. For another kiosk or gaming device to client device 207 delivery type, the gaming device 103 displays a machine-readable link code that is readable by a client device 207 (e.g., client device 207 scans the machine-readable link code and visits the link to a website served or provided by the gaming system 230). The link causes the machine-readable code to be (1) displayed and/or (2) data (including but not limited to the machine-readable code image) that includes the gaming identifier 222, the phone number 223, and/or the user credits 221, to be stored by the client gaming application 270 or a wallet application. However, in other examples, the gaming system 203 transmits the gaming identifier 222 to the gaming device 103 that originated the request.

In step 412, the gaming device 103 invokes a programmatic interface such as an API to redeem user credits. The gaming device 103 thereby enables self-service user credit 221 redemption. In the example of redeeming user credits 221, a user interacts with a user interface of the gaming device 103, and the gaming device 103 invokes a programmatic interface such as an API of a redemption system 206. The programmatic interface causes the redemption system 206 to redeem a number of user credits 221 (e.g., specified as a parameter in a redemption request that invokes the interface). The redemption system 206 redeems the user credits 221 by adding monies to a gift card, adding monies to an account preconfigured in association with the gaming identifier 222 or another redemption technique. In some examples, the redemption system 206 transmits a command to provide (e.g., dispense, initiate mailing, etc.) a gift card via the kiosk 204, point of sale device, or the gaming device 103. In some examples, this process enables the gaming device 103 to redeem user credits 221 without an attendant.

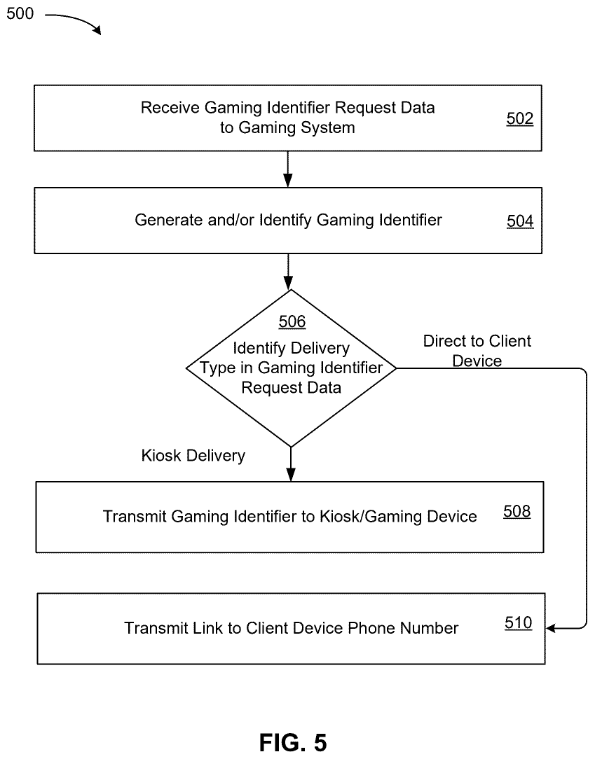

FIG. 5 is a flow diagram of method steps performed using the gaming system 203 of the gaming environment 100, according to various embodiments. Although the method steps are shown in an order, persons skilled in the art will understand that some method steps may be performed in a different order, repeated, omitted, and/or performed by components other than those described in FIG. 5. Although the method steps are described with respect to the systems of FIGS. 1-3, persons skilled in the art will understand that any system configured to perform the method steps, in any order, falls within the scope of the various embodiments.

As shown, a method 400 begins at step 502, where the gaming system 203 receives gaming identifier request data. The gaming system 203 receives gaming identifier request data from the gaming device 103 or a kiosk 204. The gaming identifier request data specifies one or more of the delivery type, the funding source, a phone number 223, an amount of funds (and/or user credits 221), and potentially other information.

At step 504, the gaming system 203 generates a gaming identifier 222 and/or identifies a predetermined gaming identifier 222. In some embodiments, the gaming system 203 uses the gaming identifier 222 to generate a data structure that includes one or more of the gaming identifier 222, a phone number 223, user credits 221, and potentially other information.

At step 506, the gaming system 203 determines or identifies a delivery type specified in the gaming identifier request data. The delivery types can be categorized in many different ways, for example the delivery type can ultimately provide the gaming identifier 222 using a player card 230 or the client device 207. Additionally, the delivery type can either involve providing the gaming identifier 222 to the player card 230 or the client device 207 via the kiosk 204 (or gaming device 103) or else the delivery type can involve directly providing the gaming identifier 222 to client device 207. If the delivery type involves the kiosk 204 or gaming device 103 to provide the gaming identifier 222, then the process proceeds to step 508. Otherwise, if the delivery type is direct to the client device 207, the process moves to step 510.

At step 508, the gaming system transmits the gaming identifier 222 (and other data) to the kiosk 204 or gaming device 103. For one kiosk or gaming device to player card 230 delivery type, the gaming device 103 embeds or stores the gaming identifier 222, and in some examples the phone number 223 and one or more user credit 221 amounts, in a chip or data store of the player card 230 and dispenses or provides the player card 230. For another kiosk or gaming device to player card 230 delivery type, the gaming device 103 prints a player card 230 that shows a machine-readable code that encodes the gaming identifier 222 and/or the phone number 223.

For a kiosk 204 to client device 207 delivery type, the kiosk 204 uses near field communication to transfer the data that includes the gaming identifier 222, the phone number 223, and/or the user credits 221 to the client device 207. For another kiosk 204 to client device 207 delivery type, the kiosk 204 displays a machine-readable link code that is readable by a client device 207 (e.g., client device 207 scans the machine-readable link code and visits the link to a website served or provided by the gaming system 230). The link causes the machine-readable code to be (1) displayed and/or (2) data (including but not limited to the machine-readable code image) that includes the gaming identifier 222, the phone number 223, and/or the user credits 221, to be stored by the client gaming application 270 or a wallet application.

At step 510, the gaming system transmits the gaming identifier 222 directly to a client device 207 using a phone number 223. For example, the gaming system 203 generates a machine-readable code that encodes the gaming identifier 222 and/or the phone number 223, generates a website that provides access to the machine-readable code (and/or data such as the machine-readable code image or other data that includes the gaming identifier 222, the phone number 223, and/or the user credits 221), and a link to the website. The gaming system 203 transmits or sends the link to client device 207 using the phone number 223 as an endpoint identifier for the client device 207, for example using short messaging service or another messaging service. The link causes the machine-readable code to be (1) displayed and/or (2) data (including but not limited to the machine-readable code image) that includes the gaming identifier 222, the phone number 223, and/or the user credits 221, to be stored by the client gaming application 270 or a wallet application.

The gaming device 103, the game system 203, the gaming kiosk 204, or other components described herein can include at least one processing circuit. Such a processing circuit can include, for example, one or more processors and one or more storage devices that are coupled to a local interface. The local interface can include, for example, a data bus with an accompanying address/control bus or any other suitable bus structure.

The one or more storage devices for a processing circuit can store data or components that are executable by the one or more processors of the processing circuit. For example, the gaming service 212, game application 227, and/or other components can be stored in one or more storage devices and be executable by one or more processors. The data stored in the storage devices can be encrypted to prevent tampering. The data can also be hashed such that a subsequent hash can be performed to determine if the data has been modified. Also, a data store 209 or 224 can be stored in the one or more storage devices.

The gaming service 212, game application 227, and/or other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

In sum, techniques are disclosed for self service activation and redemption for gaming devices, for example. The described techniques involve using player cards and client devices, including machine-readable codes that embed gaming identifiers that can be used to access user credits and other patron data. The described techniques further include systems whereby users can load credits onto a player's card for use in a gaming device without the assistance of an attendant. Additionally, examples of the disclosure also provide systems whereby users can redeem credits earned from a gaming device without needing the assistance of an attendant. Instead, unattended kiosk can be utilized to redeem credits stored on a player's card for gift cards, store credits, or other electronically redeemed rewards that can be redeemed using an application programming interface (API) over a network.

In some embodiments, the techniques include identifying, by a gaming kiosk or a gaming device, user input comprising a gaming identifier delivery type; transmitting a gaming identifier request specifying the gaming identifier delivery type; and transferring access to the gaming identifier and user credits by transmitting the gaming identifier to a client device; or adding the gaming identifier to a player card.

In further embodiments, the techniques include identifying a gaming identifier request, generating or identifying a gaming identifier, and providing the gaming identifier or a machine-readable code comprising the gaming identifier via a link transmitted to a client device phone number, data transmitted to a gaming device, or data transmitted to a gaming kiosk. In some examples, the machine-readable code includes the gaming identifier and one or more of a PIN or the telephone number for verification.

At least one technical advantage of the disclosed techniques relative to the prior art is that the disclosed techniques provide self service and redemption, thus providing greater accessibility while maintaining reliability, data security, and minimizing (or eliminating) the use of personally identifying information. In some cases, gaming devices and kiosks can verify authenticity of the gaming identifier when network access is unavailable or intermittently connected. These technical advantages represent one or more technological improvements over prior art approaches.

1. In some embodiments, a computer-implemented method comprises identifying, by a self-service device comprising a gaming kiosk or a gaming device, user input comprising a gaming identifier delivery type, transmitting, by the self-service device, a gaming identifier request specifying the gaming identifier delivery type, and transferring access to the gaming identifier and user credits by performing actions comprising at least one of transmitting the gaming identifier to a client device, or adding the gaming identifier to a player card.

2. The computer-implemented method of clause 1, further comprising invoking, by the self-service device, a programmatic interface of a redemption service to redeem at least a subset of the user credits.

3. The computer-implemented method of clauses 1 or 2, wherein the gaming identifier request further comprises at least one of a personal identification number (PIN), a telephone number, or an email address.

4. The computer-implemented method of any of clauses 1-3, wherein the gaming identifier request causes a gaming system to generate or identify the gaming identifier and associate the gaming identifier with a user account.

5. The computer-implemented method of any of clauses 1-4, wherein personally identifiable information of the user account is limited to a phone number.

6. The computer-implemented method of any of clauses 1-5, wherein transmitting the gaming identifier to the client device comprises receiving, by the self-service device, data comprising a gaming identifier, and transmitting, over a network, the gaming identifier from the self-service device to the client device.

7. The computer-implemented method of any of clauses 1-6, wherein transmitting the gaming identifier to the client device comprises generating, by a gaming system that receives the gaming identifier request, a machine readable code comprising the gaming identifier, and generating, by the gaming system, a website that provides access to the machine readable code, and transmitting, by the gaming system to the client device, a link to the website that provides access to the machine readable code.

8. The computer-implemented method of any of clauses 1-7, wherein adding the gaming identifier to a player card comprises storing the gaming identifier to a data store of the player card.

9. The computer-implemented method of any of clauses 1-8, wherein adding the gaming identifier to a player card comprises printing the gaming identifier to a surface of the player card.

10. The computer-implemented method of any of clauses 1-9, wherein the gaming identifier request further specifies at least one of an amount of funds or a number of the user credits to associate with the gaming identifier.

11. In some embodiments, one or more non-transitory computer-readable media store instructions that, when executed by one or more processors, cause the one or more processors to perform the steps of identifying, by a self-service device comprising a gaming kiosk or a gaming device, user input comprising a gaming identifier delivery type, transmitting, by the self-service device, a gaming identifier request specifying the gaming identifier delivery type, and transferring access to the gaming identifier and user credits by performing actions comprising at least one of transmitting the gaming identifier to a client device, or adding the gaming identifier to a player card.

12. The one or more non-transitory computer-readable media of clause 11, wherein the steps further comprise invoking, by the self-service device, a programmatic interface of a redemption service to redeem at least a subset of the user credits.

13. The one or more non-transitory computer-readable media of clauses 11 or 12, wherein the gaming identifier request further comprises at least one of a personal identification number (PIN), a telephone number, or an email address.

14. The one or more non-transitory computer-readable media of any of clauses 11-13, wherein the gaming identifier request causes a gaming system to generate or identify the gaming identifier and store the gaming identifier in association with the user credits.

15. The one or more non-transitory computer-readable media of any of clauses 11-14, wherein personally identifiable information stored by the gaming system is limited to a phone number.

16. The one or more non-transitory computer-readable media of any of clauses 11-15, wherein transmitting the gaming identifier to the client device comprises receiving, by the self-service device, data comprising a gaming identifier, and transmitting, over a network, the gaming identifier from the self-service device to the client device.

17. The one or more non-transitory computer-readable media of any of clauses 11-16, wherein transmitting the gaming identifier to the client device comprises generating, by a gaming system that receives the gaming identifier request, a machine readable code comprising the gaming identifier, and generating, by the gaming system, a website that provides access to the machine readable code, and transmitting, by the gaming system to the client device, a link to the website that provides access to the machine readable code.

18. The one or more non-transitory computer-readable media of any of clauses 11-17, wherein adding the gaming identifier to a player card comprises storing the gaming identifier to a data store of the player card.

19. The one or more non-transitory computer-readable media of any of clauses 11-18, wherein the gaming identifier request further specifies at least one of an amount of funds or a number of the user credits to associate with the gaming identifier.

20. In some embodiments, a system comprises a memory storing instructions, and one or more processors, that when executing the instructions, are configured to perform the steps of identifying, by a self-service device comprising a gaming kiosk or a gaming device, user input comprising a gaming identifier delivery type, transmitting, by the self-service device, a gaming identifier request specifying the gaming identifier delivery type, and transferring access to the gaming identifier and user credits by performing actions comprising at least one of transmitting the gaming identifier to a client device, or adding the gaming identifier to a player card.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

Flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
identifying, by a self-service device comprising a gaming kiosk or a gaming device, user input comprising a gaming identifier delivery type;
transmitting, by the self-service device, a gaming identifier request specifying the gaming identifier delivery type; and
transferring access to the gaming identifier and user credits by performing actions comprising at least one of:
transmitting the gaming identifier to a client device; or adding the gaming identifier to a player card.

2. The computer-implemented method of claim 1, further comprising:
invoking, by the self-service device, a programmatic interface of a redemption service to redeem at least a subset of the user credits.

3. The computer-implemented method of claim 1, wherein the gaming identifier request further comprises at least one of: a personal identification number (PIN), a telephone number, or an email address.

4. The computer-implemented method of claim 1, wherein the gaming identifier request causes a gaming system to generate or identify the gaming identifier and associate the gaming identifier with a user account.

5. The computer-implemented method of claim 4, wherein personally identifiable information of the user account is limited to a phone number.

6. The computer-implemented method of claim 1, wherein transmitting the gaming identifier to the client device comprises:
receiving, by the self-service device, data comprising a gaming identifier; and
transmitting, over a network, the gaming identifier from the self-service device to the client device.

7. The computer-implemented method of claim 1, wherein transmitting the gaming identifier to the client device comprises:
generating, by a gaming system that receives the gaming identifier request, a machine readable code comprising the gaming identifier; and
generating, by the gaming system, a website that provides access to the machine readable code; and
transmitting, by the gaming system to the client device, a link to the website that provides access to the machine readable code.

8. The computer-implemented method of claim 1, wherein adding the gaming identifier to a player card comprises:
storing the gaming identifier to a data store of the player card.

9. The computer-implemented method of claim 1, wherein adding the gaming identifier to a player card comprises:
printing the gaming identifier to a surface of the player card.

10. The computer-implemented method of claim 1, wherein the gaming identifier request further specifies at least one of: an amount of funds or a number of the user credits to associate with the gaming identifier.

11. One or more non-transitory computer-readable media storing instructions that, when executed by one or more processors, cause the one or more processors to perform the steps of:
identifying, by a self-service device comprising a gaming kiosk or a gaming device, user input comprising a gaming identifier delivery type;
transmitting, by the self-service device, a gaming identifier request specifying the gaming identifier delivery type; and
transferring access to the gaming identifier and user credits by performing actions comprising at least one of:
transmitting the gaming identifier to a client device; or adding the gaming identifier to a player card.

12. The one or more non-transitory computer-readable media of claim 11, wherein the steps further comprise:
invoking, by the self-service device, a programmatic interface of a redemption service to redeem at least a subset of the user credits.

13. The one or more non-transitory computer-readable media of claim 11, wherein the gaming identifier request further comprises at least one of: a personal identification number (PIN), a telephone number, or an email address.

14. The one or more non-transitory computer-readable media of claim 11, wherein the gaming identifier request causes a gaming system to generate or identify the gaming identifier and store the gaming identifier in association with the user credits.

15. The one or more non-transitory computer-readable media of claim 11, wherein personally identifiable information stored by the gaming system is limited to a phone number.

16. The one or more non-transitory computer-readable media of claim 11, wherein transmitting the gaming identifier to the client device comprises:
receiving, by the self-service device, data comprising a gaming identifier; and
transmitting, over a network, the gaming identifier from the self-service device to the client device.

17. The one or more non-transitory computer-readable media of claim 11, wherein transmitting the gaming identifier to the client device comprises:
generating, by a gaming system that receives the gaming identifier request, a machine readable code comprising the gaming identifier; and
generating, by the gaming system, a website that provides access to the machine readable code; and
transmitting, by the gaming system to the client device, a link to the website that provides access to the machine readable code.

18. The one or more non-transitory computer-readable media of claim 11, wherein adding the gaming identifier to a player card comprises:
storing the gaming identifier to a data store of the player card.

19. The one or more non-transitory computer-readable media of claim 11, wherein the gaming identifier request further specifies at least one of: an amount of funds or a number of the user credits to associate with the gaming identifier.

20. A system comprising:
a memory storing instructions; and
one or more processors, that when executing the instructions, are configured to perform the steps of:
identifying, by a self-service device comprising a gaming kiosk or a gaming device, user input comprising a gaming identifier delivery type;
transmitting, by the self-service device, a gaming identifier request specifying the gaming identifier delivery type; and
transferring access to the gaming identifier and user credits by performing actions comprising at least one of:
transmitting the gaming identifier to a client device; or adding the gaming identifier to a player card.
